(19) United States
(12) Patent Application Publication
(10) Pub. No.: US 2025/0189217 A1
(43) Pub. Date: Jun. 12, 2025

(54) SEPARATOR VESSEL AND INSTALLATION COMPRISING SUCH A VESSEL

(71) Applicant: L'Air Liquide, Societe Anonyme pour l'Etude et l’Exploitation des Procedes Georges Claude, Paris (FR)

(72) Inventors: Jean-Baptiste CHAIX, Paris (FR); Antony CARAFA, Paris (FR); Natacha HAIK, Paris (FR); Dominique LE LARGE, Paris (FR); Ludovic GRANADOS, Paris (FR)

(21) Appl. No.: 18/969,866

(22) Filed: Dec. 5, 2024

(30) Foreign Application Priority Data
Dec. 6, 2023 (FR) FR 2313646

(51) Int. Cl. F25J 1/02; B01D 19/00

(52) U.S. Cl. CPC F25J 1/0262; B01D 19/0042; F25J 2270/902

(57) ABSTRACT

The invention relates to a separator vessel for separating liquid and gas phases comprising a container of generally cylindrical shape extending in a longitudinal direction, which is horizontal, the lower part being provided with a downwardly extending protrusion forming an additional volume communicating with the rest of the cylindrical volume of the container, a first fluid inlet situated in the upper part thereof, a first outlet situated in the lower part of the protrusion, the first inlet and the first outlet being intended to be connected to a first heat exchanger in order to form a thermosiphon, the container comprising a second inlet, which is distinct from the first inlet, situated in the upper part thereof, and a second outlet, which is distinct from the first outlet, situated in the upper part thereof, the second inlet and the second outlet being configured to be connected to at least one second heat exchanger and to collect a fluid and to return a gaseous fluid, respectively.

### CROSS REFERENCE TO RELATED APPLICATIONS

This application claims the benefit of priority under 35 U.S.C. § 119 (a) and (b) to French patent application No. FR231346, filed Dec. 6, 2023, which is herein incorporated by reference in its entirety.

### FIELD OF THE INVENTION

The invention relates to a separator vessel and to an installation comprising such a vessel.

Certain embodiments of the invention relate more particularly to a separator vessel for separating liquid and gas phases, for example for an installation for liquefying a gas such as nitrogen or hydrogen, comprising a container of generally cylindrical shape extending in a longitudinal direction, which is horizontal in the use configuration, the lower part of the container being provided with a downwardly extending protrusion forming an additional volume communicating with the rest of the cylindrical volume of the container.

### BACKGROUND OF THE INVENTION

A separator vessel (or separation vessel) is used in cryogenic installations, such as liquefiers, to separate phases of a cryogenic fluid.

For example, in the case of nitrogen or hydrogen liquefiers, a nitrogen cycle allows at least partial cooling of the fluid to be liquefied. This cycle most often includes the following elements: a turbine, the outlet fluid of which may be two-phase, a heat exchanger operating as a thermosiphon, an additional heat exchanger, a phase separation vessel, producing liquid in the main exchanger allowing liquid to be fed to said vessel.

Such a vessel is therefore subject to multiple constraints: dimensions for incorporation in an installation, the need to be provided with multiple inlet(s) and outlet(s) allowing correct operation.

In particular, there exist horizontal and vertical separation vessels with a plurality of fluid inlets and a plurality of fluid outlets.

These various constraints do not always allow the vessel to be incorporated in complex installations in which the available space is limited.

### SUMMARY OF THE INVENTION

An aim of the present invention is to overcome all or some of the abovementioned drawbacks of the prior art.

To this end, the separator vessel according to certain embodiments of the invention, may include a container that comprises a first fluid inlet situated in the upper part thereof, a first outlet situated in the lower part of the protrusion, the first inlet and the first outlet being intended to be connected to a first heat exchanger in order to form a thermosiphon, the container comprising a second inlet, which is distinct from the first inlet, situated in the upper part thereof, and a second outlet, which is distinct from the first outlet, situated in the upper part thereof, the second inlet and the second outlet being configured to be connected to at least one second heat exchanger and to collect an at least partially liquid fluid and to return a gaseous fluid, respectively.

In certain embodiments, the present invention allows the dimensioning of a phase separator vessel to be optimized, which thus makes it possible to provide a multitude of inlets and outlets on the vessel while allowing compact dimensioning that is easily incorporated in overall architectures of cryogenic installations.

In addition, embodiments of the invention may have one or more of the following features:
the protrusion has a cylindrical shape extending along a vertical axis and a diameter that is in a plane perpendicular to the vertical axis and is between 100 mm and 2000 mm in order to limit the entrainment of bubbles with the liquid,
the height between the lower end of the protrusion and the upper end of the container is between 150 mm and the cross section or diameter of the container,
the container comprises a third outlet, which is situated in the upper part thereof and distinct from the second outlet, the third outlet being intended to be connected, for example, to a second heat exchanger in order to send a flow of gaseous fluid thereto,
the outlets situated in the upper part are offset in the longitudinal direction (A),
the container comprises a third fluid inlet configured to receive a flow of gaseous or two-phase fluid, the third fluid inlet being situated in the upper portion of the container and being distinct from the first and second inlets, and/or
the inlets situated in the upper part of the container are offset in a plane perpendicular to the longitudinal direction, for example at an angle of between 45 and 90 degrees with respect to the vertical.

In certain embodiments, the invention also may relate to a cryogenic installation comprising a separator vessel according to any one of the features above or below and a first heat exchanger, two ends of which are connected via lines to the first outlet and to the first inlet, respectively.

According to other possible particular features:
the installation comprises at least one second exchanger, two ends of which are connected via lines to the second inlet and to the second outlet, respectively,
the at least one second heat exchanger comprises a plurality of heat-exchange bodies, the various outlets are respectively connected to different heat-exchange bodies of the same heat exchanger,
the installation comprises a turbine, the delivery outlet of which is connected to an inlet of the container, for example an inlet that is also connected to the second heat exchanger, and/or
the installation comprises a feed gas circuit for feeding a gas to be liquefied, a set of one or more heat exchangers in heat exchange with the feed circuit, a cryogenic refrigerator in heat exchange with the set of one or more heat exchangers and configured to (pre) cool the feed gas circuit, the refrigerator comprising a cycle gas circuit, for example a nitrogen circuit, which is subjected to a thermodynamic cycle in order to produce a cooling power, wherein the set of one or more heat exchangers comprises at least one of the first heat exchanger and the second heat exchanger, the fluid circulating in the separator vessel via the one or more inlets and outlets is the cycle fluid.

In certain embodiments, the invention may also relate to any alternative device or method comprising any combination of the features above or below within the scope of the claims.

Further particular features and advantages will become apparent upon reading the following description, which is provided with reference to the figures, in which:

### BRIEF DESCRIPTION OF THE DRAWINGS

The invention will be understood better from reading the following description and from studying the accompanying figures. These figures are given only by way of illustration and do not in any way limit the invention.

FIG. 1 is a schematic and partial view illustrating an installation equipped with a separator vessel according to the invention.

FIG. 2 is a schematic and partial side view illustrating an example of a separator vessel according to the invention.

FIG. 3 is a schematic and partial front view illustrating an example of a separator vessel according to the invention.

FIG. 4 is a schematic and partial view illustrating another example of an installation equipped with a separator vessel according to the invention.

### DETAILED DESCRIPTION OF THE INVENTION

Throughout the figures, the same references relate to the same elements.

In this detailed description, the following embodiments are examples. Although the description refers to one or more embodiments, this does not mean that the features apply only to a single embodiment. Individual features of different embodiments may also be combined and/or interchanged in order to provide other embodiments.

The separator vessel illustrated in the figures comprises a container 1 of generally cylindrical shape extending in a longitudinal direction A, which is horizontal in the use configuration. For example, the container 1 has the general shape of a cylinder of circular cross section. The diameter (or cross section) of the container 1 is, for example, between 1000 mm and 5500 mm.

The lower part of the container 1 is provided with a downwardly extending protrusion 11 forming an additional volume communicating with the rest of the cylindrical volume of the container 1.

As illustrated, this protrusion 11 may also have a downwardly extending generally cylindrical shape (for example this cylindrical shape with a circular cross section).

For example, the protrusion 11 has a diameter that is in a plane perpendicular to the vertical axis and is between 100 mm and 2000 mm in order to limit the entrainment of bubbles with the liquid.

The dimensions of the protrusion 11 can be modified according to the size of the installation.

As illustrated, the diameter of the protrusion 11 is smaller than the diameter of the rest of the container. For example, the protrusion 11 makes it possible to create a liquid level in the main container 1 with a liquid height of no more than 500 mm.

The container 1 comprises a first fluid inlet 2 situated in the upper part thereof and a first fluid outlet 3 situated in the lower part of the protrusion 11.

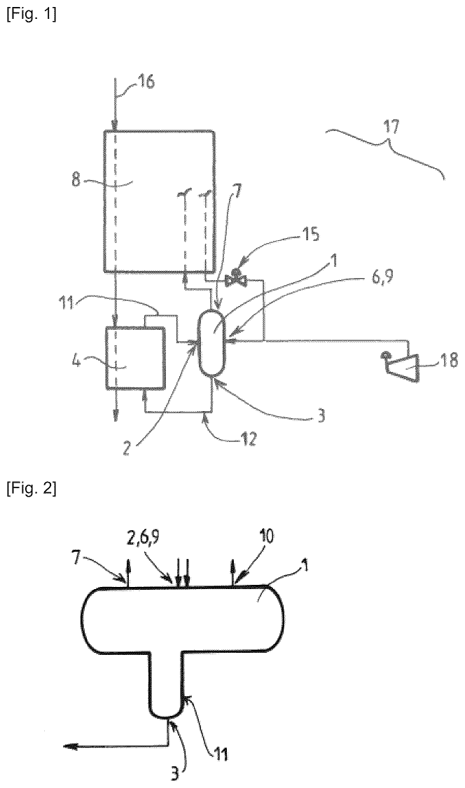

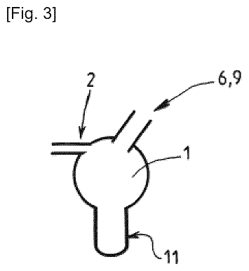

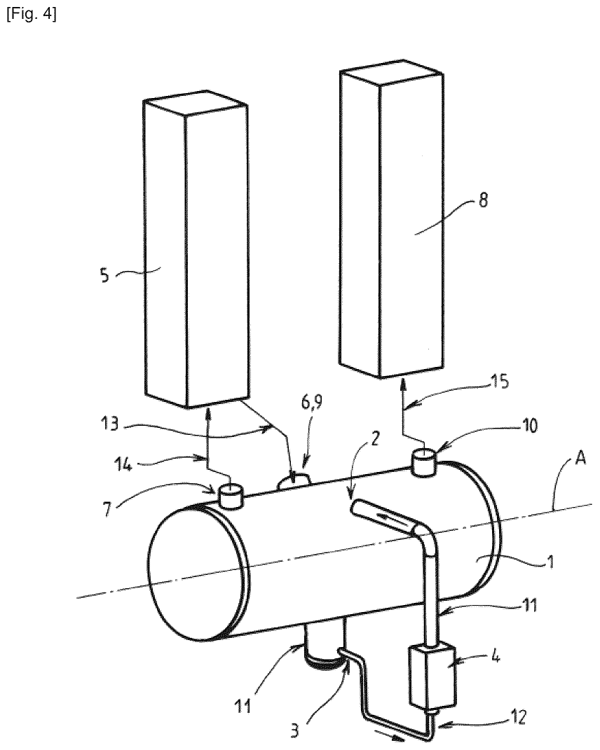

The first inlet 2 and the first outlet 3 are intended to be connected, for example, to a first heat exchanger 4 in order to form a thermosiphon (cf. FIG. 1 and FIG. 4).

The height between the lower end of the protrusion 11 (first outlet 3) and the upper end of the container 1 (first inlet 2) is preferably between 150 mm and the value of the cross section or diameter of the container 1.

This height is preferably selected so that the hydrostatic head is sufficient to feed a heat exchanger 4 as a thermosiphon and/or so that the liquid level is always present in the upper part of the container 1. The protrusion is configured so that, in operation, a sufficient hydraulic head is present above the fluid inlet of the heat exchanger.

The container 1 has a second fluid inlet 6, which is distinct from the first inlet 2. This second inlet 6 is situated in the upper part thereof.

The container 1 also has a second fluid outlet 7, which is distinct from the first outlet 3. This second outlet 7 is situated in the upper part of the container 1.

The second inlet 6 and the second outlet 7 are configured to be connected, for example, to at least one second heat exchanger 5, 8 and to collect an at least partially liquid fluid and to return a gaseous fluid, respectively.

As illustrated, the container 1 may comprise a third outlet 10, which is situated in the upper part thereof and distinct from the second outlet 7. The third outlet 10 is, for example, intended to be connected, for example, to this same second heat exchanger 8 (or another) in order to send a flow of gaseous fluid thereto.

As illustrated in particular in FIG. 4, the inlets/outlets situated in the upper part may be offset in the longitudinal direction A. For example, the second outlet 7 and the third outlet 10 are situated respectively at two longitudinal ends of the container 1, while the first 2 and second 6 inlets may be situated in the central part.

As can be seen in FIG. 3, the inlets 2, 6, 9 situated in the upper part of the container 1 may be offset in a plane perpendicular to the longitudinal direction A, for example relatively offset or oriented at an angle of between 45 and 90 degrees with respect to the vertical.

As shown schematically in FIG. 1, the container 1 may comprise a third fluid inlet 9 configured to receive a flow of gaseous or two-phase fluid. This third fluid inlet 9 is preferably situated in the upper portion of the container 1, for example in the central part, and may be distinct from the first 2 and second 6 inlets (or may be combined with either of the first and second inlets).

Thus, the phase separator vessel may therefore have one or more of the following inlets:
a first inlet 2 for receiving a two-phase fluid, for example nitrogen, from a heat exchanger 4 of a thermosiphon system,
a second inlet 6 for receiving a liquid flow, for example liquid nitrogen, from a heat exchanger 8 or from any other source. This liquid nitrogen may optionally contain a small proportion of gas as a result of flash gas produced in an expansion valve 15 arranged upstream of the separator vessel (for example less than 15 mol % of vapour fraction),
a third inlet 9 (distinct from or combined with the second inlet 6) for a gaseous or two-phase flow, for example from an expansion turbine or from the heat exchanger 8. This fluid has, for example, a liquid fraction of less than 15 mol %.

The second inlet 6 (for liquid) may be common to either of the other abovementioned inlets 2, 9. This makes it possible to minimize the number of inlets on the separator vessel in order to simplify the manufacturing thereof.

The phase separator vessel may have one or more of the following outlets:
the first outlet 3 for liquid, for example liquid nitrogen, feeding the first thermosiphon heat exchanger 4,
at least one second outlet 7 for gas (nitrogen, for example), which feeds, for example, the second heat exchanger 8.

The separator vessel illustrated in FIG. 1 in particular makes it possible for three different functions to be performed.

A first function is (liquid and gas) phase separation, for example for two-phase nitrogen from a turbine 18 (with a liquid fraction of less than 20%, for example).

A second function is feeding liquid to the first thermosiphon exchanger 4 and phase separation for the two-phase nitrogen leaving the first thermosiphon exchanger 4.

A third function is distributing gas (nitrogen, for example) to the second heat exchanger 8 (or main heat exchanger).

With regard to the first function, slightly two-phase nitrogen may require a relatively high volume flow rate to be treated. A vertical phase separator vessel would have required a very large vessel diameter and height in order to ensure good separation. The vessel according to the invention is horizontal, thereby making it possible to decrease the size of the separator vessel.

With regard to the second function, the thermosiphon between the first inlet 2 and the first outlet 3 requires a certain hydrostatic head of liquid that is determined in order to compensate for the pressure losses in the first thermosiphon exchanger 4. A horizontal vessel makes it more complex to obtain this hydrostatic head compared to a vertical vessel. The lower protrusion 11 makes it possible to solve this problem.

The cross section or diameter of this protrusion 11 may be selected so that the velocity of the liquid therein is low enough to avoid the entrainment of gas bubbles.

A liquid level must be established in the main (upper) part of the separator vessel in order to ensure good separation in the liquid phase. In addition, in order to avoid the formation of a siphon, the liquid level must also be sufficiently high (for example greater than 15 cm) with respect to the bottom and with respect to the first outlet 3 of the protrusion 11.

This dimensional parameter can be verified for the various operating cases of this separator vessel (in particular in the case of reduced operation).

With regard to the third function, the multiplicity of distinct gas outlets makes it possible to reduce the diameter of the separator vessel and therefore the bulk thereof. In fact, this makes it possible to decrease the velocity of the gas in the cross section of the separator vessel.

It is thus possible to have the following configurations for the separator vessel:
a first central two-phase inlet and two lateral gas outlets 7, 10,
two two-phase inlets and three staggered gas outlets,
two two-phase inlets and four opposite lateral gas outlets.

This shows that several configurations are possible.

The gas leaving this separator vessel can be sent to at least one heat exchanger 5, 8. This heat exchanger (for example with brazed aluminium exchanger technology) is often made of a plurality of heat-exchange bodies. It may be necessary to have a distributor between these various bodies.

With the solution presented, when the installation has four heat-exchange bodies, it is possible for two gas outlets or four gas outlets to be provided in order to distribute the flows between the various heat-exchange bodies. This makes it possible to dispense with a distributor.

The separator vessel can be made of stainless steel or aluminium. Depending on the case, it may be necessary to provide transition joints between the stainless steel separator vessel and an aluminium heat exchanger (or aluminium welds in the case of an aluminium separator vessel and an aluminium exchanger, avoiding transition joints).

The proposed architecture therefore makes it possible to optimize the incorporation of this separator vessel in the overall architecture of an installation.

Specifically, the horizontal separator vessel may be inserted beneath the heat-exchange bodies of a heat exchanger 8 and thus serve as a gas distributor for these heat-exchange bodies. The ability to superimpose the pieces of equipment makes it possible to reduce the footprint of this part without significantly increasing the height thereof and also to promote symmetrical gas distribution. This aspect is all the more advantageous since the first thermosiphon exchanger 4 can thus also be placed beneath the second, main heat exchanger 8, adjacent to this horizontal separator vessel.

Using the protrusion 11 (or lower appendage) makes it possible to limit the diameter of the horizontal container 1, this consequently limiting the space needed beneath the main heat exchanger 8.

The horizontal (or angularly offset, for example by 45 degrees) first inlet 2 and second inlet 6 make it possible to limit the space required above the separator vessel for implementing the circuitry that would have been needed in the case of a vertical inlet thereabove.

The proposed solution advantageously optimizes a horizontal phase separation vessel within a refrigeration cycle by combining a plurality of functions:
phase separation for a two-phase fluid leaving a turbine,
feeding a thermosiphon exchanger and phase separation of the two-phase return phase from this thermosiphon exchanger,
distributing the gas to the main exchanger in order to avoid adding a distributor between the various heat-exchange bodies.

The horizontal geometry of the separator vessel with multiple gas outlets and a protrusion 11 makes it possible to benefit from a sufficient hydrostatic head. This makes it possible to have a compact separator vessel that is incorporated in the overall architecture.

In the case in which a refrigeration cycle, typically a nitrogen refrigeration cycle, is used (air could also be used, for example), the installation generally comprises the following elements: a nitrogen compressor, a heat exchanger, a nitrogen turbine and a phase separator vessel. The vessel according to the invention can be incorporated therein with all or some of the above advantages.

It is possible to provide two distinct heat exchangers 4, 8: a first heat exchanger 2 referred to as thermosiphon heat exchanger in which liquid nitrogen is partially vaporized and at least one second, main heat exchanger 8 in which the gaseous nitrogen is heated.

As shown schematically in FIG. 1, the separator vessel 1 may be used in a liquefaction installation comprising a gas feed circuit 16 for feeding a gas to be liquefied, for example hydrogen. The installation comprises a set of one or more heat exchangers 8 in heat exchange with the feed circuit 16, at least one cryogenic refrigerator 17 in heat exchange with the set of one or more heat exchangers and configured to (pre) cool the feed gas circuit 16. The refrigerator 17 comprises a cycle gas circuit, for example a nitrogen circuit, which is subjected to a thermodynamic cycle in order to produce cooling power for pre-cooling the feed circuit 16.

The set of one or more heat exchangers comprises, for example, the abovementioned first thermosiphon heat exchanger 4 and at least one second heat exchanger 8. The fluid circulating in the separator vessel via the one or more inlets 2, 6, 9 and outlets 3, 7, 10 is the cycle fluid.

As illustrated, the installation comprises a turbine 18, the delivery outlet of which is connected to an inlet 6, 9 of the container 1, for example an inlet that is also connected to an outlet of the second heat exchanger 8 (via a line equipped with a valve 15).

In the example in FIG. 4, two upper outlets 7, 9 of the separator vessel feed fluid to two heat exchangers 5, 8, respectively (which are distinct from the first thermosiphon heat exchanger 4). The one or more upper inlets 6, 9 of the container 1 can be fed by the one or more heat exchangers 5, 8.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A separator vessel for separating liquid and gas phases comprising:
a container of generally cylindrical shape extending in a longitudinal direction, which is horizontal in the use configuration, a lower part of the container being provided with a downwardly extending protrusion forming an additional volume communicating with the rest of the cylindrical volume of the container, the protrusion being configured to create a liquid level in the main container with a liquid height of no more than 500 mm,
wherein the container further comprises: a first fluid inlet situated in the upper part thereof, a first outlet situated in the lower part of the protrusion, the first inlet and the first outlet being configured to be connected to a first heat exchanger in order to form a thermosiphon,
wherein the container further comprises: a second inlet, which is distinct from the first inlet, situated in an upper part thereof, and a second outlet, which is distinct from the first outlet, situated in the upper part thereof, the second inlet and the second outlet being configured to be connected to at least one second heat exchanger and to collect an at least partially liquid fluid and to return a gaseous fluid, respectively.

2. The separator vessel according to claim 1, wherein the protrusion has a cylindrical shape extending along a vertical axis and a diameter that is in a plane perpendicular to the vertical axis and is between 100 mm and 2000 mm in order to limit the entrainment of bubbles with the liquid.

3. The separator vessel according to claim 1, wherein the container comprises a third outlet, which is situated in the upper part of the container and distinct from the second outlet, the third outlet is configured to connect to the at least one second heat exchanger in order to send a flow of gaseous fluid thereto.

4. The separator vessel according to claim 3, wherein the first outlet and the second outlet situated in the upper part are offset in the longitudinal direction.

5. The separator vessel according to claim 1, wherein the container comprises a third fluid inlet configured to receive a flow of gaseous or two-phase fluid, the third fluid inlet being situated in the upper portion of the container and being distinct from the first and second inlets.

6. The separator vessel according to claim 1, wherein the inlets situated in the upper part of the container are offset in a plane perpendicular to the longitudinal direction, for example at an angle of between 45 and 90 degrees with respect to the vertical.

7. A cryogenic installation comprising:
the separator vessel according to claim 1; and
a first heat exchanger, two ends of which are connected via a first line to the first outlet and a second line to the first inlet.

8. The cryogenic installation according to claim 7, further comprising at least one second exchanger, two ends of which are connected via a third line to the second inlet and a fourth line to the second outlet.

9. The cryogenic installation according to claim 8, wherein the at least one second heat exchanger comprises a plurality of heat-exchange bodies, and in that the various outlets are respectively connected to different heat-exchange bodies of the same heat exchanger.

10. The cryogenic installation according to claim 8, further comprising a turbine having a delivery outlet of which is connected to the second inlet of the container.

11. The cryogenic installation according to claim 8, further comprising:
a feed gas circuit configured to feed a gas to be liquefied,
a set of one or more heat exchangers in heat exchange with the feed circuit,
a cryogenic refrigerator in heat exchange with the set of one or more heat exchangers and configured to cool the feed gas circuit,
wherein the cryogenic refrigerator comprises a cycle gas circuit, which is subjected to a thermodynamic cycle in order to produce a cooling power,
wherein the set of one or more heat exchangers comprises at least one of the first heat exchanger and the second heat exchanger, and
wherein the fluid circulating in the separator vessel via one or more inlets and one or more outlets is the cycle fluid, wherein the one or more inlets is selected from the group consisting of the first inlet, the second inlet, and a third fluid inlet, wherein the one or more outlets is selected from the group consisting of the first outlet, the second outlet, and a third outlet.
